(19) United States
(12) Patent Application Publication
(10) Pub. No.: US 2003/0140142 A1
(43) Pub. Date: Jul. 24, 2003

(54) Initiating connections through firewalls and network address translators

(76) Inventors: David Marples, Mansfield Notts (GB); Stanley Moyer, Mendham, NJ (US); Christian Huitema, Clyde Hill, WA (US)

Correspondence Address: Joseph Giordano, Esq., Telcordia Technologies, Inc., 445 South Street 1G112R, Morristown, NJ, 07960, US

(21) Appl. No.: 10/052,094

(22) Filed: Jan. 18, 2002

(51) Int. Cl. G06F 15/173

(52) U.S. Cl. 709/225; 709/229; 709/238

(57) ABSTRACT

Access to private devices that are separated from the public network by firewalls and NATs is provided without reconfiguring the firewalls and NATs. A private device wishing to provide access to external devices establishes a virtual private pipe to a secure hub, which includes functionality to terminate virtual pipes and to switch communications between these pipes and the public network. The secure hub assigns a secondary IP address to the private device/pipe and thereby provides the private device with a network appearance that is now beyond the firewall/NAT. External devices access the private device by addressing communications to the secondary IP address, which communications are routed to the secure hub and tunneled through the pipe to the private device. The private device can also restrict access through an access control list that is enforced by the secure hub.

### BACKGROUND OF OUR INVENTION

1. Field of the Invention

Our invention relates generally to communicating through firewalls and network address translators (NAT). More particularly, our invention relates to switching system apparatus for enabling external devices to communicate with private devices located behind firewalls and NATs by way of virtual private pipes.

2. Description of the Background

It is common for both corporations and home users to place firewalls and/or network address translators (NAT) between their local private networks and the public network. As is known, firewalls address security concerns, enforcing access control policies that regulate the types of traffic that can be sent from the local network to the public network and, perhaps more importantly, the types of traffic that can access the local network from the public network. In addition to providing some degree of security, NATs are primarily directed at IP-address scarcity and allow a set of devices on a private network to use a single IP address to interface the public network. Although differing applications, these two technologies pose a similar problem—they make it difficult for two devices (e.g., corporate/personal computers, servers, network appliances, etc.) separated by one or more firewalls/NATs to openly communicate.

For example, device 106 of FIG. 1 resides on a public network, device 102 resides on private home network that is separated from the public network 112 by a NAT 104, and device 110 resides on a private corporate network that is separated from the public network by a firewall 108. Assuming firewall 108 allows external communications, devices 102 and 110 can initiate communications with device 106. However, device 106 cannot easily initiate communications with either of devices 102 or 110 unless firewall 108 is first reconfigured to allow device 106 access, or a forwarding is first configured on NAT 104. The situation becomes somewhat worse if devices 102 and 110 wish to communicate because neither can initiate communications unless the firewall and/or NAT are first reconfigured.

Reconfiguration of firewalls and NATs is not a workable solution to the above described communications problem for several reasons. First, reconfiguration is an administrative process, which for firewalls is slow because it often requires corporate approval, and for NATs is difficult because it requires an understanding of IP, which many users do not possess. Second, the number of required reconfigurations rapidly increases as the number of devices seeking access across a firewall or NAT increases. For example, every desired peer-to-peer connection requires a separate reconfiguration. Third, security risks increase as firewalls and NATs are increasingly opened to public access.

### SUMMARY OF OUR INVENTION

Accordingly, it is desirable to provide methods and apparatus that allow devices separated by firewalls and NATs to communicate without reconfiguring the firewalls and NATs and without decreasing security, thereby overcoming the above and other disadvantages of the prior art. Under our invention, a secure hub is located in the public network and provides functionality to terminate virtual private pipes and functionality to switch communications between the public network and established virtual private pipes.

In accordance with a first embodiment of our invention, a private device that is separated from the public network by a firewall or NAT and that wishes to provide access to external devices establishes a virtual private pipe to the secure hub. The secure hub assigns and associates a secondary public IP address to the private device/pipe. To applications residing on the device, the virtual pipe and IP address are a new interface through which communications to external devices can be established. More importantly, the secure hub and virtual pipe provide the private device with a network appearance that is beyond the firewall/NAT. Hence, an external device can access the private device by addressing communications using the secondary IP address. These communications are routed to the secure hub, which associates the IP address with the pipe and tunnels the communications to the private device.

In accordance with a second embodiment of our invention, the private device provides restricted access to external devices. Here, the secure hub establishes an access control list for the private device in addition to establishing the virtual pipe as described above. To gain access to the private device, it is preferred that an external device also first establishes a virtual pipe to the secure hub. As part of the establishment procedures, the secure hub uses the access control list to determine whether the external device has permission to access the private device. Similarly, the secure hub can determine if access is granted at the time communications addressed to the private device are received from the external device. Assuming access is granted, communications are tunneled from the external device to the secure hub, which then routes and tunnels the communications to the private device. Uniquely, our invention allows a private device to provide secure access to external devices without having to reconfigure the firewall/NAT.

### BRIEF DESCRIPTION OF THE DRAWINGS

FIG. 1 depicts a prior art architecture where NATs and firewalls separate private home and corporate devices from the public network.

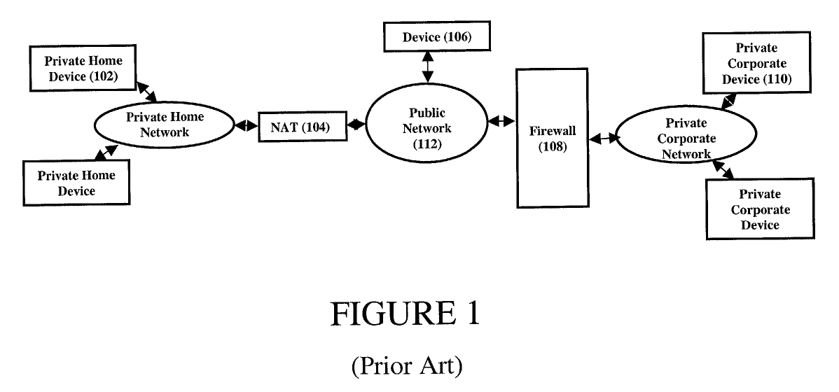

FIG. 2 depicts a first illustrative embodiment of our invention where a private device creates a secure virtual private pipe to a secure hub that then assigns and associates a public IP address to the private device/virtual pipe and thereby provides the private device with an appearance on the public network that can be accessed by external devices.

FIG. 3 depicts a second illustrative embodiment of our invention where a private device creates a secure virtual private pipe to a secure hub that also enforces restricted access to the private device and as a result, external devices also establish a secure virtual private pipe to the secure hub prior to being able to access the private device.

### DETAILED DESCRIPTION OF OUR INVENTION

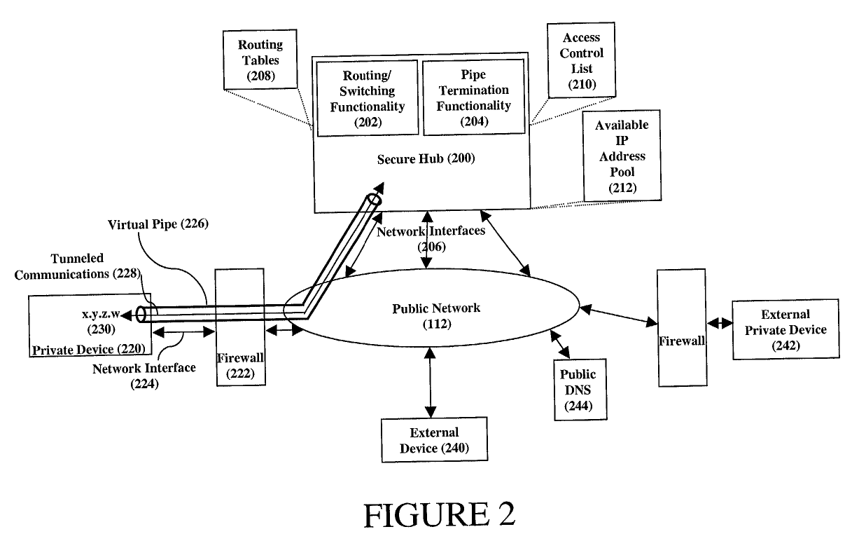

FIG. 2 shows a block diagram of secure hub 200 of our invention that allows devices outside a firewall/NAT (hereinafter, firewall will be used to collectively refer to a firewall, NAT, or other device or apparatus that similarly blocks access) to initiate communications with and gain secure access to devices behind a firewall without requiring reconfiguration of that firewall. Secure hub 200 is a switching system that resides on the public network 112 outside any firewalls. The secure hub's purpose is to allow a private device 220 behind a firewall 222 to create a network appearance on the public network to which other devices can address communications and thereby initiate communications with/access the secure device without having to address the issues posed by the firewall.

Secure hub 200 comprises one or more network interfaces 206 and routing/switching functionality 202 that allows it to switch data among these interfaces. Additionally, secure hub 200 comprises “virtual private network”/“pipe termination” functionality 204 that, combined with its switching capabilities, allows it to switch data among terminated virtual pipes and the network interfaces. Through these capabilities, a private device 220 can allow external devices, such as devices 240 and 242, to initiate communications. Specifically, private device 220 first establishes a virtual private pipe 226 over its network interface 224 and through its firewall 222 to secure hub 200. The secure hub then assigns, from an available IP address pool 212 assigned to the hub for example, a secondary IP address 230 to the private device and associates this address with the pipe. As is further described below, address 230 may be a public address or a private address with restricted access. To applications residing on device 220, virtual pipe 226 and IP address 230 are a new interface through which communications 228 to external devices can be established. For example, an application can originate communications using IP address 230, which communications are tunneled over the pipe to the secure hub and then routed over one of the hub's network interfaces 206 to the public network 112.

More importantly, the secure hub and virtual pipe 226 provide private device 220 with a network appearance that is beyond the firewall 222 and directly accessible by external devices. For example, assuming the IP address 230 is a public address, external devices 240 and 242 can address communications to this address and thereby access the private device by way of the secure hub. Communications so addressed will be routed to the secure hub, which will then associate the IP address 230 with the pipe 226 and route/tunnel the communications (228) over the pipe and through the firewall to the private device. The advantage of our invention is that by establishing a virtual pipe to secure hub 200, a private device can provide secure access to external devices without having to reconfigure the firewall.

The virtual pipe 226 can be established at the request of a user or at system startup, etc. The pipe can be implemented through such protocols as the Point-to-Point Tunnel Protocol (PPTP) or the Layer 2 Tunnel Protocol (L2TP), although our invention is not specific to the exact tunneling protocol. For security purposes, communications 228 tunneled through the pipe can be encrypted and the pipe can be configured at the private device with onward routing disallowed to ensure the pipe identifies a specific private device (or even a user on that device) and not any device located on a private networks. In addition, the secure hub can maintain a list of users who have authorization to establish a pipe and can authenticate a secure device against this list when a pipe is established.

As part of the virtual pipe establishment procedures, the secure hub will assign the private device an IP address 230, as indicated above, and may also negotiate an access control list 210 with the private device. As one option, the private device 220 may decide to allow access to any external device. In this case, the access control list 210 is not required and a public IP address must be assigned to the pipe. As such, the secure hub will obtain an available public IP address from the available IP address pool 212, configure its routing tables 208 such that the IP address 230 is associated with the pipe, notify the secure device of this address so that it may be used by applications, and update a public domain name system (DNS) server 244, for example, to allow external devices to find the secure device. Under this scenario, any external device can access the secure device by addressing all communications to this public address. The public network will route the communications to the secure hub and the secure hub will subsequently associate the address with the pipe and tunnel the communications to the private device. Once the private device has completed using the pipe, it will close the pipe and the secure hub will reallocate the IP address to the pool 212. Optionally, the secure hub may only allow the pipe to stay active for a predefined duration and, at the end of this duration, automatically close the pipe and reallocate the IP address.

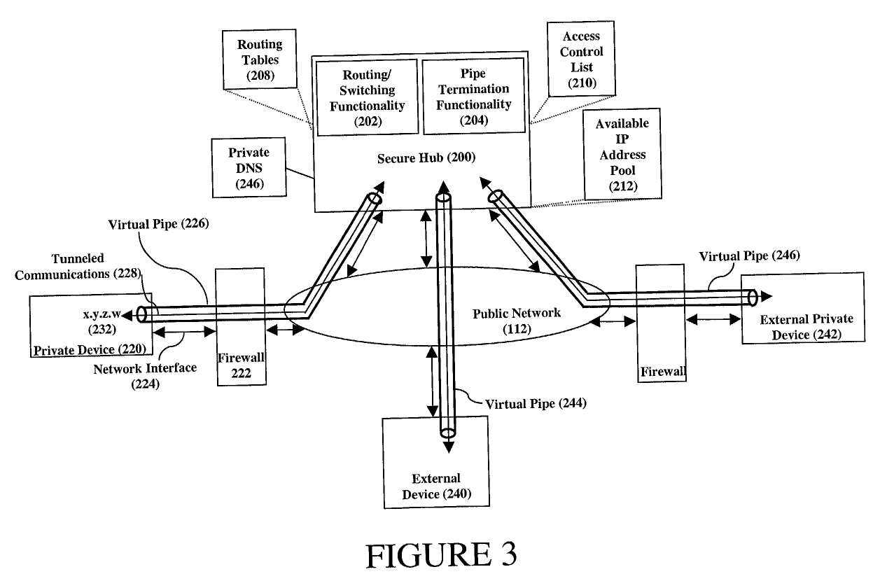

As a second option, the private device 220 may decide to restrict access to a specific set of external devices, as shown in FIG. 3. In this case, the secure hub not only acts as a switching system, switching communications to and from the virtual pipe 226, but also provides network security, selectively determining which external devices should have access to the private device. As such, the secure hub must establish and configure the access control list 210 for the private device. The access control list specifies, for example, a list of external devices or user IDs and can be established in various ways, although none is specific to our invention. For example, using a Web-based or similar interface over a connection through the virtual pipe 226, the secure hub 200 can query private device 220 for the access control information. To facilitate the implementation of selective access, it is preferred that the secure hub assigns a private IP address from the address pool 212 to the private device 220 in this case, although nothing precludes the use of a public address. Finally, the secure hub configures its routing tables 208 such that the IP address is associated with the virtual pipe 226, notifies the private device of the secondary address, and updates a private DNS server 246, for example, to allow external devices to find the private device.

To gain access to the private device 220 in this second scenario, it is preferred that an external device 240 or 242 first creates a virtual pipe 244 or 246, respectively, to secure hub 200 as described above. Again, to facilitate the implementation of selective access, a private IP address should also be assigned to the external device, although nothing precludes the use of a public address. As one option, the external device will specify to the secure hub a desire to communicate with the private device 220 as part of the pipe establishment and authentication procedures. In response to this request, the secure hub will verify that the external device is on the private device's access control list 210 and, if so, will register an indication that future communications from this device can be routed to the private device over pipe 226. Similarly, the secure hub can determine whether the external device has access to the private device at the time communications addressed to the private device are received from the external device.

Similar to above, once the secure hub has configured the virtual pipe 244 or 246 associated with the external device 240 or 242, applications on the external devices can learn of the IP address 232 associated with the private device 220 through the private DNS server 246, for example. Subsequent communications from the external device 240 or 244 addressed to the private device 220 will then be tunneled over the secure pipe 244 or 246 to the secure hub, which will then associate the IP address 232 with virtual pipe 226 and tunnel the communications to the private device 220. Once the private device 220 has completed using the pipe, it will close the pipe and the secure hub will reallocate the IP address 232 to the pool 212. Optionally, the secure hub may only allow the pipe to stay active for a predefined duration and, at the end of this duration, automatically close the pipe and reallocate the IP address.

The above-described embodiments of our invention are intended to be illustrative only. Numerous other embodiments may be devised by those skilled in the art without departing from the spirit and scope of our invention.

We claim:

1. A method performed by a hub for enabling a first device to allow communications from a second device wherein the first device is separated from the second device by access blocking apparatus, said method comprising:
terminating a virtual pipe from the first device,
assigning an IP address to the first device and associating this IP address with the virtual pipe,
receiving communications originated by the second device and addressed to said IP address,
routing the communications addressed to said IP address to the virtual pipe, and
tunneling the communications over the virtual pipe to the first device.

2. The method of claim 1 further comprising the steps of:
receiving second communications originated by the first device through the virtual pipe, and
routing the second communications from the first device to the second device.

3. The method of claim 1 further comprising the step of:
encrypting the communications prior to tunneling the communications over the virtual pipe.

4. The method of claim 1 further comprising the steps of:
receiving a plurality of communications originated by a plurality of second devices and addressed to the IP address,
routing the plurality of communications addressed to the IP address to the virtual pipe, and
tunneling the plurality of communications over the virtual pipe to the first device.

5. The method of claim 1 further comprising the steps of:
establishing an access control list to control access to the first device, and
based on the access control list, routing the communications from the second device to the first device only if the second device has permission to access the first device.

6. The method of claim 1 further comprising the steps of:
terminating a second virtual pipe from the second device,
assigning a second IP address to the second device, and
receiving the communications from the second device through the second virtual pipe.

7. The method of claim 6 wherein the IP addresses assigned to the first and second devices are private IP addresses.

8. A system for enabling communications between a first device and a second device wherein said first device is separated from said second device by access blocking apparatus, said system comprising:
a secure hub, and
a virtual pipe between the first device and said secure hub,
said secure hub including a pool of available IP addresses from which an IP address can be assigned to the first device, means for associating the assigned IP address with the virtual pipe, means for routing communications from the second device and addressed to the first device to the virtual pipe, and means for tunneling said communications over the virtual pipe to the first device.

9. The system of claim 8 wherein said means for tunneling tunnels second communications over the virtual pipe from the first device, and wherein said means for routing routes the second communications to the second device.

10. The system of claim 8 further comprising:
a virtual pipe between the second device and said secure hub, and wherein said means for associating associates a second IP address from the pool of available IP addresses with the second virtual pipe, and wherein said means for tunneling tunnels said communications from the second device through the second virtual pipe.

11. The system of claim 8 further comprising:
an access control list to control access to the first device, and wherein, based on the access control list, said means for routing the communications from the second device to the first device routes the communications only if the second device has permission to access the first device.

12. A system for enabling communication to a first communication device through the public network from a second communication device, said first and second communication devices being separated by at least one security access blocking apparatus, said system comprising
a secure hub having routing and switching functionality and pipe termination functionality and having interfaces to said public network, and
means for creating a virtual pipe between said secure hub and said first communication device for tunneling communication,
said secure hub further including means for assigning an IP address to said first communication device and associating said IP address with said virtual pipe.

13. The system of claim 12 further including means for establishing said communication from said second communication device through said public network to said secure hub.

14. The system of claim 13 wherein said means for establishing said communication from said second communication device includes means for defining a second virtual pipe.

15. The system of claim 12 wherein said secure hub includes means for defining an access control list, said routing and switching functionality routing said communication from said second communication device to said virtual pipe only if such access is permitted by said access control list.
